(19) United States
(12) Patent Application Publication
(10) Pub. No.: US 2023/0040004 A1
(43) Pub. Date: Feb. 9, 2023

(54) METHOD AND APPARATUS FOR PROCESSING PARKING SPACE STATE, AND NON-TRANSITORY COMPUTER-READABLE STORAGE MEDIUM

(71) Applicant: Apollo Intelligent Driving Technology (Beijing) Co., Ltd., Beijing (CN)

(72) Inventors: Ling DING, Beijing (CN); Jia SONG, Beijing (CN)

(73) Assignee: Apollo Intelligent Driving Technology (Beijing) Co., Ltd., Beijing (CN)

(21) Appl. No.: 17/664,900

(22) Filed: May 25, 2022

(30) Foreign Application Priority Data
Aug. 4, 2021 (CN) 202110891627.0

(51) Int. Cl. G08G 1/14; G06V 20/58; G06V 20/56

(52) U.S. Cl. CPC G08G 1/141; G08G 1/146; G06V 20/586; G06V 20/588

(57) ABSTRACT

Provided are a method and apparatus for processing a parking space state, and a non-transitory computer-readable storage medium. The method includes: acquiring parking space state association data determined by parking space monitoring devices in a target parking lot, where the parking space monitoring devices comprise an in-parking space monitoring device and an out-parking space monitoring device; determining a parking space state of a target parking space in the target parking lot according to the parking space state association data; and updating, according to the parking space state of the target parking space, parking space state data in a multi-source parking space management platform to which the target parking space belongs.

### CROSS-REFERENCE TO RELATED APPLICATION(S)

This application claims priority to Chinese Patent Application No. 202110891627.0 filed with the China National Intellectual Property Administration (CNIPA) on Aug. 4, 2021, the disclosure of which is incorporated herein by reference in its entirety.

### TECHNICAL FIELD

The present disclosure relates to the field of artificial intelligence technology and, in particular, to Internet of Things and autonomous parking technology.

### BACKGROUND

With the rapid development of economy and society, the number of motor vehicles has increased significantly, and accordingly, the number of parking lots has also increased.

In the related art, each parking lot is usually provided with its own management platform independently for drivers to make reservations so as to improve parking efficiency.

### SUMMARY

The present disclosure provides a method and apparatus for processing a parking space state, and a non-transitory computer-readable storage medium, for uniformly managing parking spaces in different parking lots.

According to an aspect of the present disclosure, a method for processing a parking space state is provided. The method includes the steps described below.

Parking space state association data determined by parking space monitoring devices in a target parking lot is acquired, where the parking space monitoring devices include an in-parking space monitoring device and an out-parking space monitoring device.

A parking space state of a target parking space in the target parking lot is determined according to the parking space state association data.

Parking space state data in a multi-source parking space management platform to which the target parking lot belongs is updated according to the parking space state of the target parking space.

According to another aspect of the present disclosure, an apparatus for processing a parking space state is further provided. The apparatus includes at least one processor; and a memory which is in a communication connection with the at least one processor; where the memory stores an instruction executable by the at least one processor, and the instruction, when executed by the at least one processor, enables the at least one processor to perform: acquiring parking space state association data determined by parking space monitoring devices in a target parking lot, where the parking space monitoring devices include an in-parking space monitoring device and an out-parking space monitoring device; determining a parking space state of a target parking space in the target parking lot according to the parking space state association data; and updating, according to the parking space state of the target parking space, parking space state data in a multi-source parking space management platform to which the target parking lot belongs.

According to another aspect of the present disclosure, a non-transitory computer-readable storage medium storing a computer instruction is further provided. The computer instruction is configured to enable a computer to perform: acquiring parking space state association data determined by parking space monitoring devices in a target parking lot, wherein the parking space monitoring devices comprise an in-parking space monitoring device and an out-parking space monitoring device; determining a parking space state of a target parking space in the target parking lot according to the parking space state association data; and updating, according to the parking space state of the target parking space, parking space state data in a multi-source parking space management platform to which the target parking lot belongs.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the present solution and not to limit the present disclosure. In the drawings:

FIG. 1 is a flowchart of a method for processing a parking space state according to an embodiment of the present disclosure;

FIG. 2 is a flowchart of a method for processing a parking space state according to an embodiment of the present disclosure;

FIG. 3 is a flowchart of another method for processing a parking space state according to an embodiment of the present disclosure;

FIG. 4 is a flowchart of another method for processing a parking space state according to an embodiment of the present disclosure;

FIG. 5 is a flowchart of another method for processing a parking space state according to an embodiment of the present disclosure;

FIG. 6 is a structural schematic diagram of an apparatus for processing a parking space state according to an embodiment of the present disclosure; and

FIG. 7 is a block diagram of an electronic device for implementing a method for processing a parking space state according to an embodiment of the present disclosure.

### DETAILED DESCRIPTION

Example embodiments of the present disclosure, including details of the embodiments of the present disclosure, are described hereinafter in conjunction with the drawings to facilitate understanding. The example embodiments are merely illustrative. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

The method and apparatus for processing a parking space state provided by the embodiments of the present disclosure are suitable for the case of uniformly managing parking spaces in different parking lots through a multi-source parking space management platform. The method for processing a parking space state provided by the embodiments of the present disclosure may be executed by the apparatus for processing a parking space state, and the apparatus is implemented by software and/or hardware and is disposed in an electronic device.

For ease of understanding, the method for processing a parking space state is first described in detail in the present disclosure.

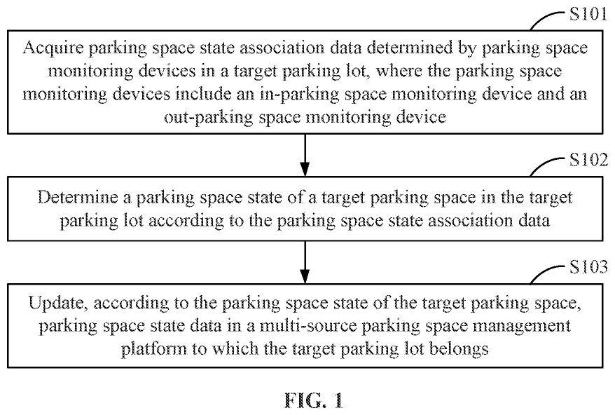

With reference to FIG. 1, a method for processing a parking space state includes S101, S102, and S103.

In S101, parking space state association data determined by parking space monitoring devices in a target parking lot is acquired, where the parking space monitoring devices include an in-parking space monitoring device and an out-parking space monitoring device.

The target parking lot is a currently to-be-managed parking lot.

The parking space monitoring devices are configured to monitor at least one parking space in the target parking lot to obtain parking space state association data that serves as the basis for determining the parking space state. The parking space state includes an idle state and an occupied state.

The parking space monitoring devices may be divided into an in-parking space monitoring device and an out-parking space monitoring device according to different positions where the parking space monitoring devices are arranged. For example, the in-parking space monitoring device is arranged inside the parking space, for example, may be a parking space lock; and the out-parking space monitoring device is arranged outside the parking space, for example, may be a monitoring device provided with a functional sensor. The functional sensor may include at least one of an image acquisition device, a laser radar or the like; and accordingly, the monitoring device may be a vehicle or a camera within the parking lot.

In an embodiment, the parking space state association data may be raw data determined by the parking space monitoring devices. For example, the parking space state association data corresponding to the parking space lock may be working state data of the parking space lock, and different preset identifiers characterize that the parking space lock is in a working state or an idle state. For another example, the parking space state association data corresponding to the image acquisition device may be the acquired original images.

In another embodiment, the parking space state association data may also be data processing results obtained after the parking space monitoring devices process the raw data of themselves. For example, the parking space state association data corresponding to the image acquisition device may be detection results obtained after the image acquisition device performs target detection or abnormality detection on an area to which the target parking space belongs in the original images acquired by itself. The target detection may include obstacle detection, and the abnormality detection may include parking space line clarity detection. It is to be noted that the target detection or the abnormality detection may be implemented in at least one manner in the related art, which is not limited herein.

In S102, a parking space state of a target parking space in the target parking lot is determined according to the parking space state association data.

The parking space state of at least one target parking space in the target parking lot is determined according to parking space state association data of at least one parking space monitoring device.

In an embodiment, the parking space state of the target parking space in the target parking lot may be determined according to the parking space state association data of any parking space monitoring device. Alternatively, in an embodiment, initial parking space states of the target parking space in the target parking lot may be determined according to parking space state association data of at least two parking space monitoring devices respectively, and the parking space state of the target parking space is comprehensively determined according to at least two initial parking space states.

For example, the step in which the parking space state of the target parking space is comprehensively determined according to at least two initial parking space states may be that an initial parking space state is selected according to the priorities of parking space monitoring devices corresponding to the initial parking space states, and the selected parking space state is taken as the parking space state of the target parking space.

For example, the step in which the parking space state of the target parking space is comprehensively determined according to at least two initial parking space states may be that statistic is performed on at least two initial parking space states, and an initial parking space state with a high statistical result is taken as the parking space state of the target parking space. Preferably, an initial parking space state with the highest statistical result is taken as the parking space state of the target parking space.

For example, the step in which the parking space state of the target parking space is comprehensively determined according to at least two initial parking space states may be that if at least two initial parking space states include an occupied state, the parking space state of the target parking space is directly determined as the occupied state; otherwise, the parking space state of the target parking space is determined as an idle state.

It is to be noted that some parking spaces may be in a non-idle state, and these parking spaces cannot be used due to objective reasons, for example, abnormal ground conditions (accumulated water, potholes, bulges, etc.) in the parking space. In order to distinguish such parking spaces, an abnormal state may also be set among the parking space states, or an abnormal identifier may be marked in the occupied state, to achieve the purpose of distinguishing and marking abnormal parking spaces, which is convenient for staff to eliminate abnormalities in a targeted manner.

In S103, parking space state data in a multi-source parking space management platform to which the target parking lot belongs is updated according to the parking space state of the target parking space.

The multi-source parking space management platform may be understood as a management platform for uniformly managing at least one parking space in at least one parking lot, and such a platform may display parking space state data to drivers or management users of vehicles so that the drivers or management users select parking spaces to park vehicles. Of course, in order to reduce user operation, the multi-source parking space management platform may also automatically allocate parking spaces for vehicles according to the current position of vehicles. It is to be noted that the allocation mechanism of parking spaces is not limited in the present disclosure.

In this embodiment of the present disclosure, parking space state association data determined by parking space monitoring devices in a target parking lot is acquired, where the parking space monitoring devices include an in-parking space monitoring device and an out-parking space monitoring device; a parking space state of a target parking space in the target parking lot is determined according to the parking space state association data; and parking space state data in a multi-source parking space management platform to which the target parking space belongs updated according to the parking space state of the target parking space. In the preceding scheme, with the introduction of parking space state association data of parking space monitoring devices of each parking lot, the unified and integrated management of parking spaces in different parking lots in a multi-source parking space management platform can be achieved, and no independent management platform needs to be set for each parking lot, thereby improving the convenience of managing parking spaces in different parking lots. Meanwhile, with the introduction of an in-parking space monitoring device and an out-parking space monitoring device to determine the parking space state association data, the defects that a single monitoring device cannot determine the parking space state of the target parking space or the parking space state result determined by a single monitoring device is inaccurate are remedied, which is helpful to improve the comprehensiveness and accuracy of the determination result of the parking space state.

The present disclosure further provides an embodiment on the basis of the preceding scheme. In the embodiment, the operation of acquiring the parking space state association data is optimized and improved to improve data acquisition efficiency and reduce unnecessary data transmission.

It is to be noted that for parts not described in detail in this embodiment of the present disclosure, reference may be made to the description of the preceding embodiments.

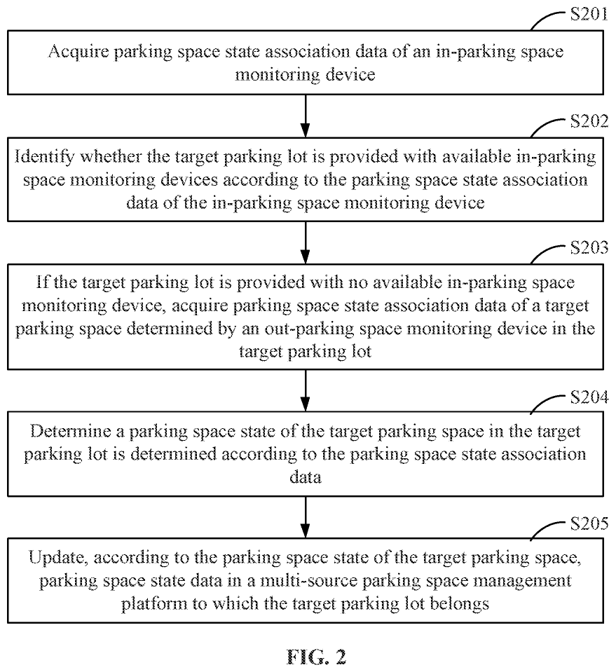

With reference to FIG. 2, a method for processing a parking space state includes S201, S202, S203, S204, and S205.

In S201, parking space state association data of an in-parking space monitoring device is acquired.

Since the in-parking space monitoring device is arranged inside the target parking space, the parking space state association data may relatively accurately reflect the actual result of the parking space state of the target parking space. Thus, the parking space state association data of the in-parking space monitoring device may be acquired first as the basis for determining the parking space state of the target parking space.

In S202, whether the target parking lot is provided with available in-parking space monitoring devices is identified according to the parking space state association data of the in-parking space monitoring device.

Since some target parking spaces are not equipped with any in-parking space monitoring device, the parking space state association data cannot be acquired from the in-parking space monitoring device; or if the in-parking space monitoring device is abnormal (for example, the device is damaged or suffers from power failure), the valid parking space state association data cannot be acquired from the in-parking space monitoring device, which will affect the accuracy of the determination result of the parking space state of the target parking space.

Therefore, whether the target parking lot is provided with available in-parking space monitoring devices needs to be identified according to the parking space state association data of the in-parking space monitoring device.

For example, if the parking space state association data acquired from the in-parking space monitoring device is null or has an abnormal identifier, it is determined that no available parking space monitoring device is provided in the target parking lot; and if the parking space state association data acquired from the in-parking space monitoring device has a working state identifier or an idle state identifier, it is determined that the available parking space monitoring devices are provided in the target parking lot.

In S203, if the target parking lot is provided with no available in-parking space monitoring device, parking space state association data of a target parking space determined by an out-parking space monitoring device in the target parking lot is acquired.

In S204, a parking space state of the target parking space in the target parking lot is determined according to the parking space state association data.

In an embodiment, if it is identified that the target parking lot is provided with no available in-parking space monitoring device, the parking space state association data of the target parking space determined by the out-parking space monitoring device in the target parking lot is acquired as supplementary data of the in-parking space monitoring device; and a second initial parking space state of the target parking space is determined according to the parking space state association data of the out-parking space monitoring device, and the second initial parking space state is taken as the final parking space state of the target parking space.

In another embodiment, if it is identified that the target parking lot is provided with available in-parking space monitoring devices, a first initial parking space state of the target parking space is determined according to the parking space state association data of the in-parking space monitoring device; and the first initial parking space state is directly taken as the final parking space state of the target parking space.

In another embodiment, if it is identified that the target parking lot is provided with available in-parking space monitoring devices, a first initial parking space state of the target parking space is determined according to the parking space state association data of the in-parking space monitoring device; a second initial parking space state of the target parking space is determined according to the parking space state association data of the out-parking space monitoring device; and the final parking space state of the target parking space is determined according to at least one of the first initial parking space state or the second initial parking space state.

In an embodiment, the step in which the final parking space state of the target parking space is determined according to at least one of the first initial parking space state or the second initial parking space state may be that if the first initial parking space state is consistent with the second initial parking space state, the consistent result is taken as the final parking space state of the target parking space; otherwise, it is determined that the final parking space state of the target parking space is an abnormal state or an occupied state.

Alternatively, in an embodiment, the step in which the final parking space state of the target parking space is determined according to at least one of the first initial parking space state or the second initial parking space state may be that if the first initial parking space state is an occupied state, the first initial parking space state is directly taken as the final parking space state of the target parking space; and if the first initial parking space state is an abnormal state or an idle state, the second initial parking space state is taken as the final parking space state of the target parking space.

In S205, parking space state data in a multi-source parking space management platform to which the target parking lot belongs is updated according to the parking space state of the target parking space.

For each target parking space in different target parking lots in the multi-source parking space management platform, the parking space state data in the multi-source parking space management platform is updated according to the final parking space state of the target parking space.

In this embodiment of the present disclosure, the operation of acquiring the parking space state association data is refined into that the parking space state association data of the in-parking space monitoring device is acquired; whether the target parking lot is provided with available parking space monitoring devices is identified according to the parking space state association data of the in-parking space monitoring device; only in a case where no available in-parking space monitoring device is provided, the parking space state association data of the target parking space determined by the out-parking space monitoring device in the target parking lot is acquired; and the parking space state of the target parking space is determined, so that the redundant acquisition and calculation of the parking space state association data are avoided while ensuring the accuracy and comprehensiveness of the parking space state in the multi-source parking space management platform, thereby saving the data transmission bandwidth, reducing the data calculation amount, and further improving the parking space state determination efficiency.

On the basis of the preceding schemes, in this embodiment of the present disclosure, the out-parking space monitoring device is set to include a movable out-parking space monitoring device in the target parking lot and/or a fixed out-parking space monitoring device in the target parking lot, to improve the richness of the out-parking space monitoring device.

It is to be noted that for parts not described in detail in this embodiment of the present disclosure, reference may be made to the description of the preceding embodiments.

The movable out-parking space monitoring device may move to collect the parking space state association data, such as vehicles to be parked, pilot cars leading vehicles to park in a parking lot or an operation terminal of staff in the parking lot; and the fixed out-parking space monitoring device is, for example, a camera within the parking lot that is fixed in a set area of the parking lot, such as a carport, a support column or a railing.

It is to be understood that with the arrangement of at least one out-parking space monitoring device, parking space state association data from different sources can be provided, and the comprehensiveness and richness of parking space state association data can be improved, which is helpful to improve the accuracy of the determination result of the parking space state of the target parking space.

The process of processing the parking space state of the target parking lot provided with different out-parking space monitoring devices will be described below in detail.

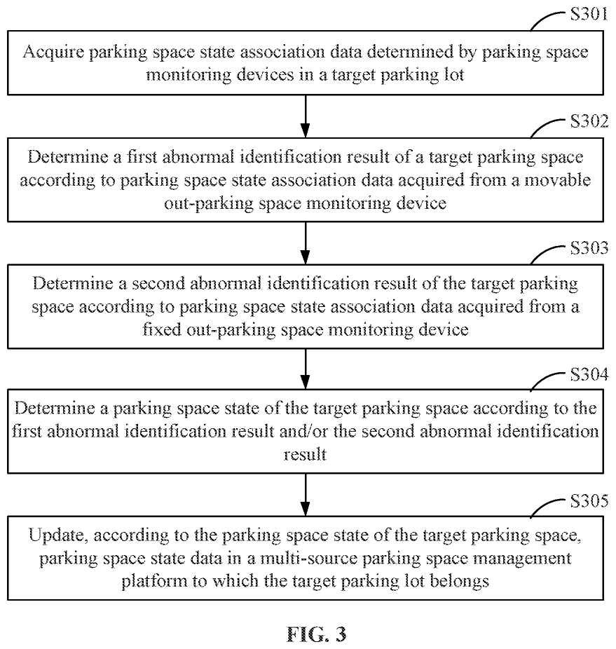

With reference to FIG. 3, a method for processing a parking space state includes S301, S302, S303, S304, and S305.

In S301, parking space state association data determined by parking space monitoring devices in a target parking lot is acquired, where the parking space monitoring devices include an in-parking space monitoring device and an out-parking space monitoring device, and the out-parking space monitoring device includes a movable out-parking space monitoring device in the target parking lot and/or a fixed out-parking space monitoring device in the target parking lot.

In S302, a first abnormal identification result of a target parking space is determined according to parking space state association data acquired from the movable out-parking space monitoring device.

In S303, a second abnormal identification result of the target parking space is determined according to parking space state association data acquired from the fixed out-parking space monitoring device.

The abnormal identification results are used for characterizing abnormal conditions of the target parking space respectively determined based on the parking space state association data of the movable out-parking space monitoring device or the parking space state association data of the fixed out-parking space monitoring device. For example, the conditions include whether there are potholes, accumulated water or other obstacles in the target parking space to affect the parking of vehicles or whether parking space lines of the target parking space are not clear, which affects the parking of unmanned vehicles.

In an embodiment, whether an obstacle exists in the target parking space and whether a parking space line of the target parking space is clear may be identified according to the parking space state association data acquired from the movable out-parking space monitoring device; if the obstacle exists in the target parking space or the parking space line is not clear, it is determined that the first abnormal identification result is an abnormal state; and if no obstacle exists in the target parking space or the parking space line is clear, it is determined that the first abnormal identification result is a normal state.

In another embodiment, whether an obstacle exists in the target parking space and whether a parking space line of the target parking space is clear may be identified according to the parking space state association data acquired from the fixed out-parking space monitoring device; if the obstacle exists in the target parking space or the parking space line is not clear, it is determined that the second abnormal identification result is an abnormal state; and if no obstacle exists in the target parking space or the parking space line is clear, it is determined that the second abnormal identification result is a normal state.

It is to be noted that since the obstacle exists in the target parking space, if a vehicle to be parked is parked in this target parking space, the vehicle may be damaged to a certain extent, so it is necessary to mark such a target parking space as abnormal. Since the parking space line of the target parking space is unclear, it may lead to the inability of vehicle drivers or unmanned vehicles to accurately park during the parking process, which will bring certain potential safety hazards to their own vehicles or surrounding vehicles, so it is necessary to mark such target vehicles as abnormal. It is to be understood that with the identification of abnormal parking spaces in the preceding manners, the richness and comprehensiveness of the abnormal parking space identification are improved, which is helpful to improve the accuracy of the parking space state identification results of the target parking space.

In the present disclosure, the identification of the obstacle existing in the target parking space and the identification of the clarity of the parking space line of the target parking space may be achieved by adopting at least one scheme in the related art, and the specific identification manners are not limited herein.

In S304, a parking space state of the target parking space is determined according to the first abnormal identification result and/or the second abnormal identification result.

For example, a first initial parking space state of a target parking space is determined according to the parking space state association data acquired from the in-parking space monitoring device; a second initial parking space state of the target parking space is determined according to the first abnormal identification result and/or the second abnormal identification result; and the final parking space state of the target parking space is determined according to the first initial parking space state and/or the second initial parking space state.

In an embodiment, if the first abnormal identification result or the second abnormal identification result is an abnormal state, the second initial parking space state is determined to be an occupied state or an abnormal state; and if both the first abnormal identification result and the second abnormal identification result are a normal state, the second initial parking space state is an idle state. It is to be understood that with the determination of the second initial parking space state in this manner, the false identification of parking spaces in the idle state caused by incorrect determination results of some out-parking space monitoring devices can be effectively avoided, and the accuracy of the determination result of the second initial parking space state can be effectively improved, which is helpful to improve the accuracy of the determination result of the final parking space state of the target parking space.

Alternatively, in an embodiment, if the first abnormal identification result is an abnormal state, the second initial parking space state is determined to be an occupied state or an abnormal state; if the first abnormal identification result is a normal state and the second abnormal identification result is an abnormal state, the second initial parking space state is determined to be an occupied state or an abnormal state; and if the first abnormal identification result is a normal state and the second abnormal identification result is a normal state, the second initial parking space state is determined to be an idle state. It is to be understood that with the determination of the second initial parking space state in this manner, the first abnormal identification result can be supplemented by the second abnormal identification result, thereby avoiding the missing identification of parking spaces in the occupied state or the abnormal state, effectively improving the accuracy of the determination result of the second initial parking space state, which is helpful to improve the accuracy of the determination result of the final parking space state of the target parking space.

For the determination of the final parking space state of the target vehicle according to the first initial parking space state and/or the second initial parking space state, reference may be made to the description of the related contents of the preceding embodiments, and the details are not repeated here.

In S305, parking space state data in a multi-source parking space management platform to which the target parking lot belongs is updated according to the parking space state of the target parking space.

In this embodiment of the present disclosure, the operation of determining the parking space state is refined into that the first abnormal identification result of the target parking space is determined according to parking space state association data acquired from the movable out-parking space monitoring device; the second abnormal identification result of the target parking space is determined according to parking space state association data acquired from the fixed out-parking space monitoring device; and the parking space state of the target parking space is determined according to the first abnormal identification result and/or the second abnormal identification result. Through the preceding scheme, the parking space state of the target parking space can be determined using the parking space state association data of different kinds of out-parking space monitoring devices, thereby improving the richness and comprehensiveness of parking space state association data, which is helpful to improve the accuracy of the determination result of the parking space state of the target parking space.

The present disclosure further provides an embodiment on the basis of the preceding schemes. In the embodiment, the process of acquiring and using the parking space state association data is optimized and improved to reduce unnecessary data transmission.

It is to be noted that for parts not described in detail in this embodiment of the present disclosure, reference may be made to the related description of the preceding embodiments.

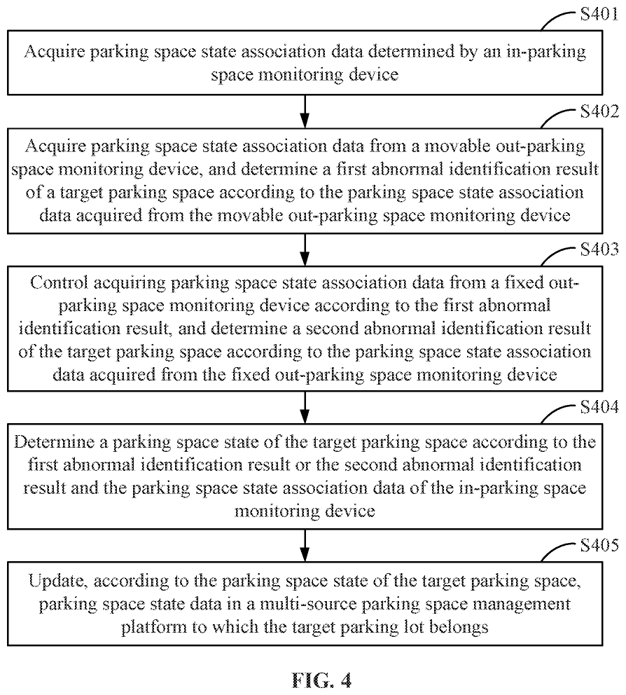

With reference to FIG. 4, a method for processing a parking space state includes S401, S402, S403, S404, and S405.

In S401, parking space state association data determined by an in-parking space monitoring device is acquired.

In S402, parking space state association data is acquired from a movable out-parking space monitoring device, and a first abnormal identification result of a target parking space is determined according to the parking space state association data acquired from the movable out-parking space monitoring device.

In S403, acquiring parking space state association data from a fixed out-parking space monitoring device is controlled according to the first abnormal identification result, and a second abnormal identification result of the target parking space is determined according to the parking space state association data acquired from the fixed out-parking space monitoring device.

In S404, the parking space state of the target parking space is determined according to the first abnormal identification result or the second abnormal identification result and the parking space state association data of the in-parking space monitoring device.

In an embodiment, if the first abnormal identification result is an abnormal state, it is unnecessary to acquire the parking space state association data from the fixed out-parking space monitoring device, and the parking space of the target parking space is directly determined according to the first abnormal identification result and the parking space state association data of the in-parking space monitoring device. It is to be understood that through the preceding scheme, the acquisition and processing of the parking space state association data of the fixed out-parking space monitoring device are reduced, thereby reducing the data transmission bandwidth and the data processing amount, which is helpful to improve the determination efficiency of the parking space state of the target parking space.

In another embodiment, if the first abnormal identification result is a normal state, the parking space state association data is acquired from the fixed out-parking space monitoring device, and the second abnormal identification result of the target parking space is determined according to the parking space state association data acquired from the fixed out-parking space monitoring device; and the parking space state of the target parking space is determined according to the first abnormal identification result or the second abnormal identification result and the parking space state association data of the in-parking space monitoring device. It is to be understood that through the preceding scheme, the parking space state association data of the fixed out-parking space monitoring device can be acquired in a case where the missing identification occurs in the first abnormal identification result, and the second abnormal identification result determined based on the parking space state association data of the fixed out-parking space monitoring device serves as the supplementary solution, thereby avoiding the situation of missing identification of the abnormal identification result of the parking space, which is helpful to improve the accuracy of the determination result of the parking space state of the target parking space.

For example, a first initial parking space state of a target parking space is determined according to the parking space state association data acquired from the in-parking space monitoring device; a second initial parking space state of the target parking space is determined according to the first abnormal identification result and/or the second abnormal identification result; and the final parking space state of the target parking space is determined according to the first initial parking space state and/or the second initial parking space state.

In an embodiment, if the first abnormal identification result is an abnormal state, the second initial parking space state is directly determined to be an occupied state or an abnormal state; if the first abnormal identification result is a normal state and the second abnormal identification result is an abnormal state, the second initial parking space state is determined to be an occupied state or an abnormal state; and if the first abnormal identification result is a normal state and the second abnormal identification result is a normal state, the second initial parking space state is determined to be an idle state. It is to be understood that with the determination of the second initial parking space state in this manner, the false identification of parking spaces in the idle state caused by incorrect determination results of some out-parking space monitoring devices can be effectively avoided, and the accuracy of the determination result of the second initial parking space state can be effectively improved, which is helpful to improve the accuracy of the determination result of the final parking space state of the target parking space.

For the determination of the final parking space state of the target vehicle according to the first initial parking space state and/or the second initial parking space state, reference may be made to the description of the related contents of the preceding embodiments, and the details are not repeated here.

In S405, parking space state data in a multi-source parking space management platform to which the target parking lot belongs is updated according to the parking space state of the target parking space.

In the embodiment of the present disclosure, acquiring the parking space state association data of the fixed out-parking space monitoring device is controlled based on the first abnormal identification result determined according to the parking space state association data of the movable out-parking space monitoring device, thereby avoiding the redundant acquisition and calculation of data and reducing the data transmission bandwidth and data processing mount, which is helpful to improve the determination efficiency of the parking space state of the target parking space. In addition, if necessary, the parking space state association data is acquired from the fixed out-parking space monitoring device, which is used as the supplementary determination solution of the abnormal parking space, which effectively avoids the occurrence of the missing identification of the abnormal parking space and is helpful to improve the accuracy of the determination result of the parking space state of the target parking space.

The present disclosure further provides a preferred embodiment on the basis of the preceding schemes. In this embodiment, the in-parking space monitoring device is specifically refined into a parking space lock, the movable out-parking space monitoring device is specifically refined into a vehicle to be parked, the fixed out-parking space monitoring device is specifically refined into a camera within the parking lot, and in this case, the method for processing a parking space state of the present disclosure is described in detail.

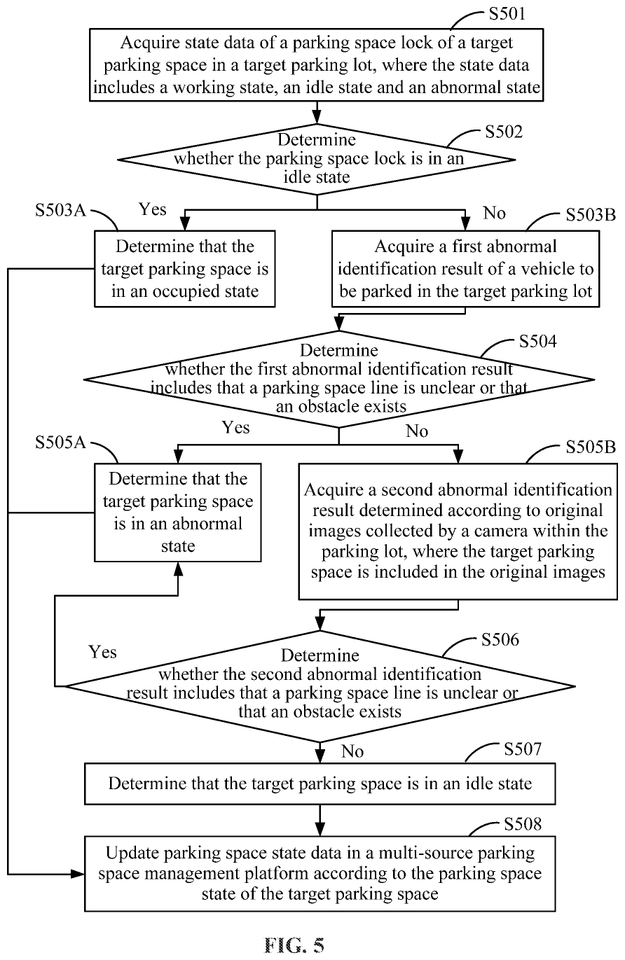

With reference to FIG. 5, a method for processing a parking space state is executed by an operation server of a multi-source parking space management platform and includes S501, S502, S503A, S503B, S504, S505A, S505B, S506, S507, and S508.

In S501, state data of a parking space lock of a target parking space in a target parking lot is acquired, where the state data includes a working state, an idle state and an abnormal state.

The abnormal state characterizes that the parking space lock is not set or that the parking space lock fails.

In S502, whether the parking space lock is in an idle state is determined; if the parking space lock is in the idle state, perform S503A; and if the parking space lock is not in an idle state, perform S503B.

In S503A, it is determined that the target parking space is in an occupied state. The method then proceeds to perform S508.

In S503B, a first abnormal identification result of a vehicle to be parked in the target parking lot is acquired. The method then proceeds to perform S504.

For example, the first abnormal identification result may be determined by the vehicle to be parked based on the environment images and/or radar data collected by itself, or the first abnormal identification result is determined by an operation server of a multi-source parking space management platform after the vehicle to be parked sends the environment images and/or radar data collected by the vehicle to the operation server.

The first abnormal identification result includes the clarity condition of the parking space line of the target parking space and the existence of obstacles in the target parking space.

In S504, whether the first abnormal identification result includes that a parking space line is unclear or that an obstacle exists is determined; if the first abnormal identification result includes that the parking space line is unclear or that the obstacle exists, return to perform S505A; otherwise, perform S505B.

In S505A, it is determined that the target parking space is in an abnormal state. The method then proceeds to perform S508.

In S505B, a second abnormal identification result determined according to original images collected by a camera within the parking lot is acquired, where the target parking space is included in the original images. The method then proceeds to perform S506.

For example, obstacle identification and parking space line clarity identification may be performed on the target parking space in the original images to obtain the second abnormal identification result. The second abnormal identification result may be determined by the camera within the parking lot or by the operation server of the multi-source parking space management platform.

In S506, whether the second abnormal identification result includes that a parking space line is unclear or that an obstacle exists is determined; if the second abnormal identification result includes that the parking space line is unclear or that an obstacle exists, return to perform S505A; otherwise, perform S507.

In S507, it is determined that the target parking space is in an idle state. The method then proceeds to perform S508.

In S508, parking space state data in a multi-source parking space management platform is updated according to the parking space state of the target parking space.

It is to be understood that with the determination of the parking space state of the target parking space through the state data of the parking space lock, data collected or determined by the vehicle to be parked and data collected or determined by the camera within the parking lot, the richness and comprehensiveness of the determination basis of the parking space state can be improved, thereby improving the accuracy of the determination result of the parking space state of the target parking space. In addition, when the parking space state cannot be determined through certain data, other data are used for a supplement, thereby improving the comprehensiveness of manageable target parking spaces in the parking lot. Meanwhile, with the unified and integrated management of parking spaces in different parking lots, the convenience of parking space management is improved.

As the implementation of the preceding method for processing a parking space state, the present disclosure further provides an embodiment of an apparatus for performing the method for processing a parking space state.

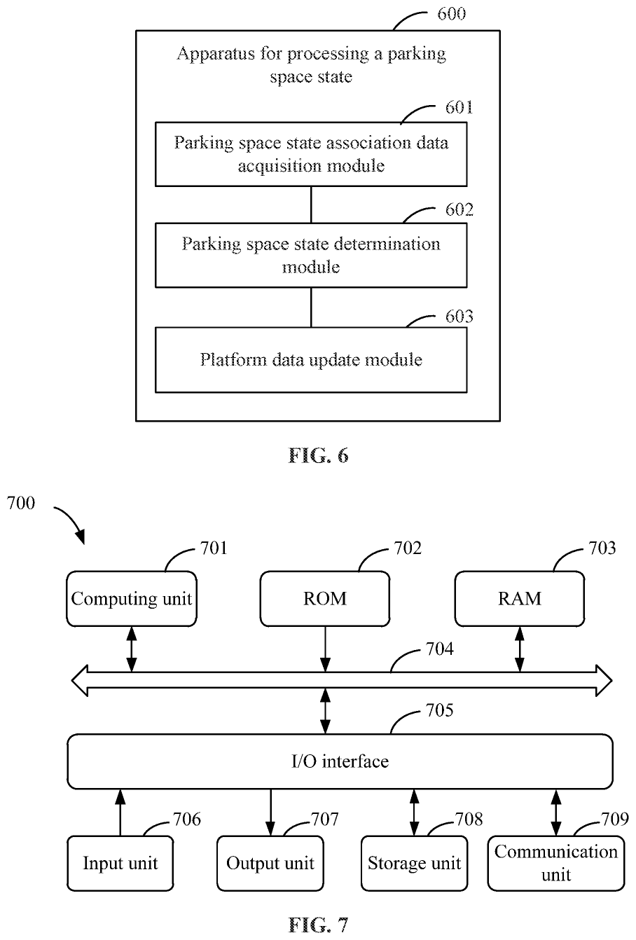

Further, with reference to FIG. 6, an apparatus 600 for processing a parking space state includes a parking space state association data acquisition module 601, a parking space state determination module 602, and a platform data update module 603.

The parking space state association data acquisition module 601 is configured to acquire parking space state association data determined by parking space monitoring devices in a target parking lot, where the parking space monitoring devices include an in-parking space monitoring device and an out-parking space monitoring device.

The parking space state determination module 602 is configured to determine a parking space state of a target parking space in the target parking lot according to the parking space state association data.

The platform data update module 603 is configured to update, according to the parking space state of the target parking space, parking space state data in a multi-source parking space management platform to which the target parking lot belongs.

In the embodiment of the present disclosure, the parking space state association data acquisition module acquires parking space state association data determined by parking space monitoring devices in a target parking lot, where the parking space monitoring devices include an in-parking space monitoring device and an out-parking space monitoring device; the parking space state determination module determines a parking space state of a target parking space in the target parking lot according to the parking space state association data; and the platform data update module updates, according to the parking space state of the target parking space. In the preceding solution, parking space state data in a multi-source parking space management platform to which the target parking lot belongs. With the introduction of parking space state association data of parking space monitoring devices of each parking lot, the unified and integrated management of parking spaces in different parking lots in a multi-source parking space management platform can be achieved, and no independent management platform needs to be set for each parking lot, thereby improving the convenience of managing parking spaces in different parking lots. Meanwhile, with the introduction of an in-parking space monitoring device and an out-parking space monitoring device to determine the parking space state association data, the defects that a single monitoring device cannot determine the parking space state of the target parking space or the parking space state result determined by a single monitoring device is inaccurate are remedied, which is helpful to improve the comprehensiveness and accuracy of the determination result of the parking space state.

In an embodiment, the parking space state association data acquisition module 601 includes an in-parking space data acquisition unit, an in-parking space identification unit, and an out-parking space data acquisition unit.

The in-parking space data acquisition unit is configured to acquire parking space state association data of the in-parking space monitoring device.

The in-parking space identification unit is configured to identify whether the target parking lot is provided with available in-parking space monitoring devices according to the parking space state association data of the in-parking space monitoring device.

The out-parking space data acquisition unit is configured to, if the target parking lot is provided with no available in-parking space monitoring device, acquire parking space state association data of the target parking space determined by the out-parking space monitoring device in the target parking lot.

In an embodiment, the out-parking space monitoring device includes a movable out-parking space monitoring device in the target parking lot and/or a fixed out-parking space monitoring device in the target parking lot.

In an embodiment, the parking space state determination module 602 includes a first abnormal identification result determination unit, a second abnormal identification result determination unit, and a parking space state determination unit.

The first abnormal identification result determination unit is configured to determine a first abnormal identification result of the target parking space according to parking space state association data acquired from the movable out-parking space monitoring device.

The second abnormal identification result determination unit is configured to determine a second abnormal identification result of the target parking space according to the parking space state association data acquired from the fixed out-parking space monitoring device.

The parking space state determination unit is configured to determine the parking space state of the target parking space according to the first abnormal identification result and/or the second abnormal identification result.

In an embodiment, the parking space state association data acquisition module 601 includes a movable out-parking space monitoring device data acquisition unit.

The movable out-parking space monitoring device data acquisition unit is configured to acquire parking space state association data from the movable out-parking space monitoring device.

The parking space state determination module 602 includes a first abnormal identification result determination unit, which is configured to determine a first abnormal identification result of the target parking space according to the parking space state association data acquired from the movable out-parking space monitoring device.

The parking space state association data acquisition module 601 further includes a fixed out-parking space monitoring device data acquisition unit, which is configured to control acquiring parking space state association data from the fixed out-parking space monitoring device according to the first abnormal identification result.

The parking space state determination module 602 further includes a second abnormal identification result determination unit, which is configured to determine a second abnormal identification result of the target parking space according to the parking space state association data acquired from the fixed out-parking space monitoring device.

The parking space state determination module 602 further includes a parking space state determination unit, which is configured to determine the parking space state of the target parking space according to the first abnormal identification result or the second abnormal identification result.

In an embodiment, the first abnormal identification result determination unit includes an obstacle and parking space line identification sub-unit and a first abnormal identification result determination sub-unit.

The obstacle and parking space line identification sub-unit is configured to identify whether an obstacle exists in the target parking space and whether a parking space line of the target parking space is clear according to the parking space state association data acquired from the movable out-parking space monitoring device.

The first abnormal identification result determination sub-unit is configured to, if the obstacle exists in the target parking space or the parking space line is not clear, determine that the first abnormal identification result is an abnormal state; and if no obstacle exists in the target parking space or the parking space line is clear, determine that the first abnormal identification result is a normal state.

In an embodiment, the second abnormal identification result determination unit includes an obstacle and parking space line identification sub-unit and a second abnormal identification result determination sub-unit.

The obstacle and parking space line identification sub-unit is configured to identify whether an obstacle exists in the target parking space and whether a parking space line of the target parking space is clear according to the parking space state association data acquired from the fixed out-parking space monitoring device.

The second abnormal identification result determination sub-unit is configured to, if the obstacle exists in the target parking space or the parking space line is not clear, determine that the second abnormal identification result is an abnormal state; and if no obstacle exists in the target parking space or the parking space line is clear, determine that the second abnormal identification result is a normal state.

The preceding apparatus for processing a parking space state may perform the method for processing a parking space state provided in any embodiment of the present disclosure and has function modules and beneficial effects corresponding to the performed method for processing a parking space state.

In the schemes of the present disclosure, acquisition, storage and application of the parking space state association data involved herein are in compliance with relevant laws and regulations and do not violate the public order and good customs.

According to an embodiment of the present disclosure, the present disclosure further provides an electronic device, a readable storage medium and a computer program product.

FIG. 7 is a block diagram of an example electronic device 700 for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile device, for example, a personal digital assistant, a cellphone, a smartphone, a wearable device or another similar computing device. Herein the shown components, the connections and relationships between these components, and the functions of these components are illustrative only and are not intended to limit the implementation of the present disclosure as described and/or claimed herein.

As shown in FIG. 7, the device 700 includes a computing unit 701. The computing unit 701 may perform various types of appropriate operations and processing based on a computer program stored in a read-only memory (ROM) 702 or a computer program loaded from a storage unit 708 to a random-access memory (RAM) 703. Various programs and data required for operations of the device 700 may also be stored in the RAM 703. The computing unit 701, the ROM 702 and the RAM 703 are connected to each other via a bus 704. An input/output (I/O) interface 705 is also connected to the bus 704.

Multiple components in the device 700 are connected to the I/O interface 705. The multiple components include an input unit 706 such as a keyboard and a mouse, an output unit 707 such as various types of displays and speakers, the storage unit 708 such as a magnetic disk and an optical disk, and a communication unit 709 such as a network card, a modem and a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Some examples of the computing unit 701 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 701 performs various methods and processing described above, such as the method for processing a parking space state. For example, in some embodiments, the method for processing a parking space state may be implemented as a computer software program tangibly contained in a machine-readable medium such as the storage unit 708. In some embodiments, part or all of a computer program may be loaded and/or installed on the device 700 via the ROM 702 and/or the communication unit 709. When the computer program is loaded to the RAM 703 and executed by the computing unit 701, one or more steps of the preceding method for processing a parking space state may be executed. Alternatively, in other embodiments, the computing unit 701 may be configured, in any other suitable manner (for example, by means of firmware), to perform the method for processing a parking space state.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on a chip (SoCs), complex programmable logic devices (CPLDs), computer hardware, firmware, software and/or combinations thereof. The embodiments may include implementations in one or more computer programs. The one or more computer programs are executable, interpretable, or executable and interpretable on a programmable system including at least one programmable processor. The programmable processor may be a dedicated or general-purpose programmable processor for receiving data and instructions from a memory system, at least one input device and at least one output device and transmitting the data and instructions to the memory system, the at least one input device and the at least one output device.

Program codes for implementing the methods of the present disclosure may be compiled in any combination of one or more programming languages. These program codes may be provided for a processor or controller of a general-purpose computer, a special-purpose computer or another programmable data processing device such that the program codes, when executed by the processor or controller, cause functions/operations specified in the flowcharts and/or block diagrams to be implemented. The program codes may be executed in whole on a machine, executed in part on a machine, executed, as a stand-alone software package, in part on a machine and in part on a remote machine, or executed in whole on a remote machine or a server.

In the context of the present disclosure, the machine-readable medium may be a tangible medium that may include or store a program that is used by or used in conjunction with a system, apparatus or device that executes instructions. The machine-readable medium may be a machine-readable signal medium or a machine-readable storage medium. The machine-readable medium may include, but are not limited to, electronic, magnetic, optical, electromagnetic, infrared or semiconductor systems, apparatuses or devices or any suitable combinations thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of devices may also be used for providing interaction with a user. For example, feedback provided for the user can be sensory feedback in any form (for example, visual feedback, auditory feedback or haptic feedback). Moreover, input from the user can be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service. The server may also be a server of a distributed system or a server combined with blockchain.

Artificial intelligence is a discipline that studies making computers simulate some thinking processes and intelligent behaviors (such as learning, reasoning, thinking, planning, and the like) of humans, and has both hardware-level technologies and software-level technologies. The artificial intelligence hardware technologies generally include technologies such as sensors, special artificial intelligence chips, cloud computing, distributed storage, big data processing, and the like. The artificial intelligence software technologies mainly include computer vision technology, speech recognition technology, natural language processing technology, machine learning/deep learning technology, big data processing technology, knowledge map technology, and the like.

Cloud computing refers to a technical system that accesses flexible and scalable shared physical or virtual resource pools through the network, in which resources can include servers, operating systems, networks, software, applications and storage devices, and deploys and manages resources on demand and in a self-service manner. The cloud computing technology can provide efficient and powerful data processing capabilities for artificial intelligence, blockchain and other technology applications and model training.

It is to be understood that various forms of the preceding flows may be used, with steps reordered, added or removed. For example, the steps described in the present disclosure may be executed in parallel, in sequence or in a different order as long as the desired result of the technical solution disclosed in the present disclosure is achieved. The execution sequence of these steps is not limited herein.

The scope of the present disclosure is not limited to the preceding embodiments. It is to be understood by those skilled in the art that various modifications, combinations, sub-combinations and substitutions may be made depending on design requirements and other factors. Any modifications, equivalent substitutions, improvements and the like made within the spirit and principle of the present disclosure is within the scope of the present disclosure.

What is claimed is:

1. A method for processing a parking space state, comprising:
acquiring parking space state association data determined by parking space monitoring devices in a target parking lot, wherein the parking space monitoring devices comprise an in-parking space monitoring device and an out-parking space monitoring device;
determining a parking space state of a target parking space in the target parking lot according to the parking space state association data; and
updating, according to the parking space state of the target parking space, parking space state data in a multi-source parking space management platform to which the target parking lot belongs.

2. The method according to claim 1, wherein acquiring the parking space state association data determined by the parking space monitoring devices in the target parking lot comprises:
acquiring parking space state association data of the in-parking space monitoring device;
identifying whether the target parking lot is provided with available in-parking space monitoring devices according to the parking space state association data of the in-parking space monitoring device; and
if the target parking lot is provided with no available in-parking space monitoring device, acquiring parking space state association data determined by the out-parking space monitoring device in the target parking lot.

3. The method according to claim 1, wherein the out-parking space monitoring device comprises at least one of a movable out-parking space monitoring device in the target parking lot or a fixed out-parking space monitoring device in the target parking lot.

4. The method according to claim 2, wherein the out-parking space monitoring device comprises at least one of a movable out-parking space monitoring device in the target parking lot or a fixed out-parking space monitoring device in the target parking lot.

5. The method according to claim 3, wherein determining the parking space state of the target parking space in the target parking lot according to the parking space state association data comprises:
determining a first abnormal identification result of the target parking space according to parking space state association data acquired from the movable out-parking space monitoring device;
determining a second abnormal identification result of the target parking space according to parking space state association data acquired from the fixed out-parking space monitoring device; and
determining the parking space state of the target parking space according to at least one of the first abnormal identification result or the second abnormal identification result.

6. The method according to claim 3, wherein acquiring the parking space state association data determined by the parking space monitoring devices in the target parking lot and determining the parking space state of the target parking space in the target parking lot according to the parking space state association data comprises:
acquiring parking space state association data from the movable out-parking space monitoring device, and determining a first abnormal identification result of the target parking space according to the parking space state association data acquired from the movable out-parking space monitoring device;
controlling acquiring parking space state association data from the fixed out-parking space monitoring device according to the first abnormal identification result, and determining a second abnormal identification result of the target parking space according to the parking space state association data acquired from the fixed out-parking space monitoring device; and
determining the parking space state of the target parking space according to the first abnormal identification result or the second abnormal identification result.

7. The method according to claim 5, wherein determining the first abnormal identification result of the target parking space according to the parking space state association data acquired from the movable out-parking space monitoring device comprises:
identifying whether an obstacle exists in the target parking space and whether a parking space line of the target parking space is clear according to the parking space state association data acquired from the movable out-parking space monitoring device; and
if the obstacle exists in the target parking space or the parking space line is not clear, determining that the first abnormal identification result is an abnormal state; and if no obstacle exists in the target parking space or the parking space line is clear, determining that the first abnormal identification result is a normal state.

8. The method according to claim 6, wherein determining the first abnormal identification result of the target parking space according to the parking space state association data acquired from the movable out-parking space monitoring device comprises:
identifying whether an obstacle exists in the target parking space and whether a parking space line of the target parking space is clear according to the parking space state association data acquired from the movable out-parking space monitoring device; and
if the obstacle exists in the target parking space or the parking space line is not clear, determining that the first abnormal identification result is an abnormal state; and if no obstacle exists in the target parking space or the parking space line is clear, determining that the first abnormal identification result is a normal state.

9. The method according to claim 5, wherein determining the second abnormal identification result of the target parking space according to the parking space state association data acquired from the fixed out-parking space monitoring device comprises:
identifying whether an obstacle exists in the target parking space and whether a parking space line of the target parking space is clear according to the parking space state association data acquired from the fixed out-parking space monitoring device; and
if the obstacle exists in the target parking space or the parking space line is not clear, determining that the second abnormal identification result is an abnormal state; and if no obstacle exists in the target parking space or the parking space line is clear, determining that the second abnormal identification result is a normal state.

10. The method according to claim 6, wherein determining the second abnormal identification result of the target parking space according to the parking space state association data acquired from the fixed out-parking space monitoring device comprises:
identifying whether an obstacle exists in the target parking space and whether a parking space line of the target parking space is clear according to the parking space state association data acquired from the fixed out-parking space monitoring device; and
if the obstacle exists in the target parking space or the parking space line is not clear, determining that the second abnormal identification result is an abnormal state; and if no obstacle exists in the target parking space or the parking space line is clear, determining that the second abnormal identification result is a normal state.

11. An apparatus for processing a parking space state, comprising: at least one processor; and a memory which is in a communication connection with the at least one processor; wherein the memory stores an instruction executable by the at least one processor, and the instruction, when executed by the at least one processor, enables the at least one processor to perform:
acquiring parking space state association data determined by parking space monitoring devices in a target parking lot, wherein the parking space monitoring devices comprise an in-parking space monitoring device and an out-parking space monitoring device;
determining a parking space state of a target parking space in the target parking lot according to the parking space state association data; and
updating, according to the parking space state of the target parking space, parking space state data in a multi-source parking space management platform to which the target parking lot belongs.

12. The apparatus according to claim 11, wherein the instruction, when executed by the at least one processor, enables the at least one processor to perform acquiring the parking space state association data determined by the parking space monitoring devices in the target parking lot by the following way:
acquiring parking space state association data of the in-parking space monitoring device;
identifying whether the target parking lot is provided with available in-parking space monitoring devices according to the parking space state association data of the in-parking space monitoring device; and
if the target parking lot is provided with no available in-parking space monitoring device, acquiring parking space state association data determined by the out-parking space monitoring device in the target parking lot.

13. The apparatus according to claim 11, wherein the out-parking space monitoring device comprises at least one of a movable out-parking space monitoring device in the target parking lot or a fixed out-parking space monitoring device in the target parking lot.

14. The apparatus according to claim 12, wherein the out-parking space monitoring device comprises at least one of a movable out-parking space monitoring device in the target parking lot or a fixed out-parking space monitoring device in the target parking lot.

15. The apparatus according to claim 13, wherein the instruction, when executed by the at least one processor, enables the at least one processor to perform determining the parking space state of the target parking space in the target parking lot according to the parking space state association data in the following way:
determining a first abnormal identification result of the target parking space according to parking space state association data acquired from the movable out-parking space monitoring device;
determining a second abnormal identification result of the target parking space according to parking space state association data acquired from the fixed out-parking space monitoring device; and
determining the parking space state of the target parking space according to at least one of the first abnormal identification result or the second abnormal identification result.

16. The apparatus according to claim 13, wherein the instruction, when executed by the at least one processor, enables the at least one processor to perform acquiring the parking space state association data determined by the parking space monitoring devices in the target parking lot and determining the parking space state of the target parking space in the target parking lot according to the parking space state association data in the following way:
acquiring parking space state association data from the movable out-parking space monitoring device; and determining a first abnormal identification result of the target parking space according to the parking space state association data acquired from the movable out-parking space monitoring device;
controlling acquiring parking space state association data from the fixed out-parking space monitoring device according to the first abnormal identification result; and determining a second abnormal identification result of the target parking space according to the parking space state association data acquired from the fixed out-parking space monitoring device; and
determining the parking space state of the target parking space according to the first abnormal identification result or the second abnormal identification result.

17. The apparatus according to claim 15, wherein the instruction, when executed by the at least one processor, enables the at least one processor to perform determining the first abnormal identification result of the target parking space according to the parking space state association data acquired from the movable out-parking space monitoring device in the following way:
identifying whether an obstacle exists in the target parking space and whether a parking space line of the target parking space is clear according to the parking space state association data acquired from the movable out-parking space monitoring device; and
if the obstacle exists in the target parking space or the parking space line is not clear, determining that the first abnormal identification result is an abnormal state; and if no obstacle exists in the target parking space or the parking space line is clear, determining that the first abnormal identification result is a normal state.

18. The apparatus according to claim 16, wherein the instruction, when executed by the at least one processor, enables the at least one processor to perform determining the first abnormal identification result of the target parking space according to the parking space state association data acquired from the movable out-parking space monitoring device in the following way:
identifying whether an obstacle exists in the target parking space and whether a parking space line of the target parking space is clear according to the parking space state association data acquired from the movable out-parking space monitoring device; and
if the obstacle exists in the target parking space or the parking space line is not clear, determining that the first abnormal identification result is an abnormal state; and if no obstacle exists in the target parking space or the parking space line is clear, determining that the first abnormal identification result is a normal state.

19. The apparatus according to claim 15, wherein the instruction, when executed by the at least one processor, enables the at least one processor to perform determining the second abnormal identification result of the target parking space according to the parking space state association data acquired from the fixed out-parking space monitoring device in the following way:
identifying whether an obstacle exists in the target parking space and whether a parking space line of the target parking space is clear according to the parking space state association data acquired from the fixed out-parking space monitoring device; and
if the obstacle exists in the target parking space or the parking space line is not clear, determining that the second abnormal identification result is an abnormal state; and if no obstacle exists in the target parking space or the parking space line is clear, determining that the second abnormal identification result is a normal state.

20. A non-transitory computer-readable storage medium storing a computer instruction, wherein the computer instruction is configured to enable a computer to perform:
acquiring parking space state association data determined by parking space monitoring devices in a target parking lot, wherein the parking space monitoring devices comprise an in-parking space monitoring device and an out-parking space monitoring device;
determining a parking space state of a target parking space in the target parking lot according to the parking space state association data; and
updating, according to the parking space state of the target parking space, parking space state data in a multi-source parking space management platform to which the target parking lot belongs.
